(19) United States
(12) Patent Application Publication
(10) Pub. No.: US 2026/0080889 A1
(43) Pub. Date: Mar. 19, 2026

(54) METHOD FOR GENERATING DIGITAL HUMAN, INTELLIGENT AGENT, ELECTRONIC DEVICE AND STORAGE MEDIUM

(71) Applicant: Beijing Baidu Netcom Science Technology Co., Ltd., Beijing (CN)

(72) Inventors: Xing LIU, Beijing (CN); Jinbo WU, Beijing (CN); Xiaobo GAO, Beijing (CN); Jialun LIU, Beijing (CN); Taotao ZHANG, Beijing (CN); Chen ZHAO, Beijing (CN); Yingying LI, Beijing (CN); Haocheng FENG, Beijing (CN); Errui DING, Beijing (CN); Jingdong WANG, Beijing (CN)

(21) Appl. No.: 19/402,143

(22) Filed: Nov. 26, 2025

(30) Foreign Application Priority Data
Dec. 28, 2024 (CN) 202411963903.X

(51) Int. Cl. G10L 21/10; G06T 7/11; G06T 11/00; G06V 10/40; G06V 10/764

(52) U.S. Cl. CPC G10L 21/10; G06T 7/11; G06T 11/10; G06V 10/40; G06V 10/764; G10L 2021/105

(57) ABSTRACT

Provided is a method for generating a digital human, an intelligent agent, an electronic device and a storage medium, relating to the field of artificial intelligence technology, and particularly to the fields of computer vision, deep learning, large model, augmented reality and other technologies. The method includes: segmenting a target object from an image to be processed to obtain a target sub-image; selecting a digital human to be optimized that is compatible with the target object from a digital human set based on the target sub-image; generating clothing texture of the digital human to be optimized based on an appearance feature of the target object in the target sub-image; applying the clothing texture to the digital human to be optimized to obtain a target digital human; and driving the target digital human.

### CROSS-REFERENCE TO RELATED APPLICATIONS

The present application claims priority to Chinese Patent Application No. CN202411963903.X, filed with the China National Intellectual Property Administration on Dec. 28, 2024, the disclosure of which is hereby incorporated herein by reference in its entirety.

### TECHNICAL FIELD

The present disclosure relates to the field of artificial intelligence technology, and particularly to the fields of computer vision, deep learning, large model, augmented reality and other technologies, and can be applied to digital human and other scenarios.

### BACKGROUND

With the rapid advancement of AIGC (Artificial Intelligence Generated Content) technology, digital humans, as an emerging form of human-computer interaction, are gradually entering the public eye and receiving widespread attention. The digital humans can not only imitate human appearance and behavior, but also achieve natural dialogue and emotional exchange with humans through deep learning and natural language processing technologies. The digital human technology will play an important role in various applications.

### SUMMARY

The present disclosure provides a method for generating a digital human, an intelligent agent, an apparatus, a device and a storage medium.

According to one aspect of the present disclosure, provided is a method for generating a digital human, including:
segmenting a target object from an image to be processed to obtain a target sub-image;
selecting a digital human to be optimized that is compatible with the target object from a digital human set based on the target sub-image;
generating clothing texture of the digital human to be optimized based on an appearance feature of the target object in the target sub-image;
applying the clothing texture to the digital human to be optimized to obtain a target digital human; and
driving the target digital human.

According to yet another aspect of the present disclosure, provided is an intelligent agent, including:
an interactive interface configured to obtain an image to be processed;
an artificial intelligence module configured to segment a target object from the image to be processed to obtain a target sub-image; select a digital human to be optimized that is compatible with the target object from a digital human set based on the target sub-image; and generate clothing texture of the digital human to be optimized based on an appearance feature of the target object in the target sub-image; and
a rendering engine configured to apply the clothing texture to the digital human to be optimized to obtain a target digital human; and drive the target digital human.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flowchart of a method for generating a digital human according to a first embodiment of the present disclosure;

FIG. 2 is a schematic diagram of a process of selecting a compatible digital human to be optimized according to a second embodiment of the present disclosure;

FIG. 3 is a schematic diagram of a process of generating the clothing texture of the digital human to be optimized according to a third embodiment of the present disclosure;

FIG. 4 is a schematic diagram of a process of generating the clothing texture of the digital human to be optimized according to a fourth embodiment of the present disclosure;

FIG. 5 is a structural schematic diagram of an intelligent agent according to a fifth embodiment of the present disclosure;

FIG. 6 is a schematic diagram of the framework of the method for generating the digital human according to a sixth embodiment of the present disclosure;

FIG. 7 is a structural schematic diagram of an apparatus for generating a digital human according to a seventh embodiment of the present disclosure; and

FIG. 8 is a block diagram of an electronic device for implementing the method for generating the digital human in the embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

The terms “first”, “second” and the like in the present disclosure are used to distinguish the similar objects, but not necessarily to describe a particular order or sequence. In addition, the terms “include” and “have” and any variations thereof are intended to cover a non-exclusive inclusion. For example, a method, system, product or device containing a series of steps or units is not necessarily limited to those steps or units listed clearly, but may include other steps or units that are not listed clearly or that are inherent to the process, method, product or device.

People have a wide range of interests and hobbies, from electronic products to cute pets. For example, cat lovers span all age groups, and like to record pet cats'daily lives by taking photos or recording videos.

While simply taking photos or recording videos can capture the wonderful moments of cute pets, new technologies are still needed to enhance the user experience and provide emotional value to users.

With the development of artificial intelligence and digital human technologies, many applications can be improved on this basis to enhance the user experience.

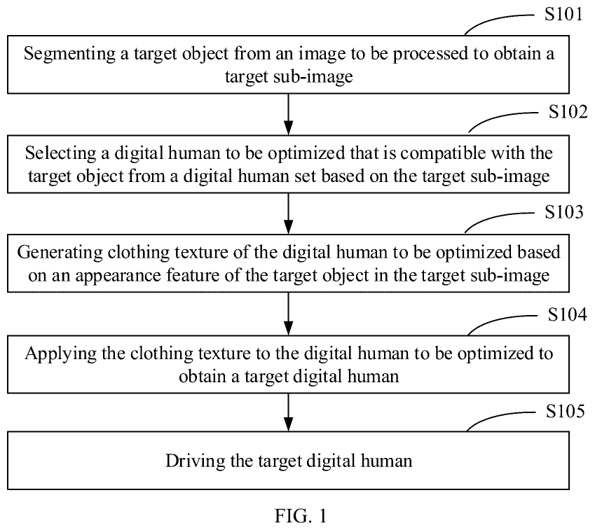

In view of this, an embodiment of the present disclosure provides a method for generating a digital human. This method can generate and drive personalized digital humans based on images to enhance the user experience. As shown in FIG. 1, the schematic flowchart of this method is as follows:

S101: segmenting a target object from an image to be processed to obtain a target sub-image.

Here, the image to be processed may be an image uploaded by a user, such as an image of a cute pet taken.

The target object in the image to be processed may be any one of animals, plants and man-made objects. Here, the animals are for example cute pets; the plants are for example jasmine, rose, snake plant, etc. ; the man-made objects are items created by humans using certain technologies and processes, and may be simple tools or complex high-tech products. The “man-made objects” in the embodiment of the present disclosure refer to items with specific appearance, such as shield, hangtag, doll, etc.

During implementation, the image to be processed may be input into a target detection model to detect the position of the target object, thereby obtaining the 2D (Two Dimensions) position box of the target object in the image to be processed. Then, the target object is cropped from the image to be processed based on the 2D position box, so as to segment the target object from the image to be processed to obtain the target sub-image.

S102: selecting a digital human to be optimized that is compatible with the target object from a digital human set based on the target sub-image.

In the embodiment of the present disclosure, the target object and the digital human to be optimized may belong to different species. For example, the target object is a pet cat, while the digital human to be optimized is a personified virtual avatar. It can be understood that the digital human refers to a personified virtual avatar with vision, voice and behavior generated by computer technology.

For example, the target object is an image of a cute pet, and at least some features of the cute pet may be transferred to the digital human to be optimized, to implement personification of the cute pet.

In some embodiments, the digital human set may be a cartoon digital human set. The cartoon digital humans have common features similar to cute pets and popular with users, so the digital humans selected from the cartoon digital human set can provide users with the positive and proactive emotional value, improving the user experience.

In some embodiments, a digital human aesthetically compatible with the target object may be selected from the digital human set as the digital human to be optimized.

The aesthetic compatibility is a concept that involves the application of aesthetic principles in different fields, and emphasizes the coordination and integration between aesthetics and practical applications. The aesthetic compatibility can be understood as applying aesthetic principles and aesthetic values to the target object and the field of digital human, so as to smoothly transfer some of the user's intuitive feelings from the target object to the digital human, which can be understood as personifying the target object to provide the user with more emotional value, and extending the user's liking for the target object through technological means, so as to provide the user with more emotional value and improve the user experience.

S103: generating clothing texture of the digital human to be optimized based on an appearance feature of the target object in the target sub-image.

Here, the appearance feature is external manifestation of a product or target, and may include at least one or a combination of shape, pattern, color and other visual elements. In computer vision, the appearance feature may refer to a visual attribute of a target in an image, such as at least one of color, texture, or shape, etc.

The digital human to be optimized in the embodiment of the present disclosure may already have a stylized face, a personified body and clothing style, but the clothing texture needs to be generated according to the target object, to implement personification of the target object.

S104: applying the clothing texture to the digital human to be optimized to obtain a target digital human.

S105: driving the target digital human.

In conclusion, in the embodiment of the present disclosure, the segmentation of the target object from the image to be processed can remove the irrelevant or secondary information, allowing subsequent processing to focus on the target object. By selecting the digital human to be optimized that is compatible with the target object and generating the clothing texture of the digital human to be optimized based on the target object, the appearance feature of the target object can be transferred to the digital human, achieving the generation of the personalized digital human based on the target object in the image, and enabling the target object to be personified. By further driving the target digital human, the target digital human can provide the user with more emotional value through human-like operations, further improving the user experience.

Furthermore, if the selection of the aesthetically compatible digital human can meet the aesthetic requirement in terms of aesthetics, the important features of the target object can be smoothly transferred to the target digital human, so that the target object and the target digital human resonate with each other and create a linkage. Then, the user's feelings about the target object can be transferred to the target digital human from an aesthetic perspective, thereby providing the user with more emotional value and further improving the user experience.

In the embodiment of the present disclosure, the digital human to be optimized includes a two-dimensional character model. Here, the two-dimensional culture has formed a unique community culture, where enthusiasts build social connections and cultural identities by sharing their love for specific works or characters. The two-dimensional character has a wide audience and is one of the consumption hotspots for young people today to satisfy their emotional values. Therefore, using the two-dimensional character model as the digital human to be optimized can meet people's aesthetic requirement, especially when the target object is a pet. The two-dimensional character model and the pet have similar characteristics, such as being cute and soft. Thus the selected digital human to be optimized can associate the target object with the digital human in some sensory characteristics, thereby generating a compatible and personalized target digital human based on the target object in the image, providing the user with more emotional value, and thus improving the user experience.

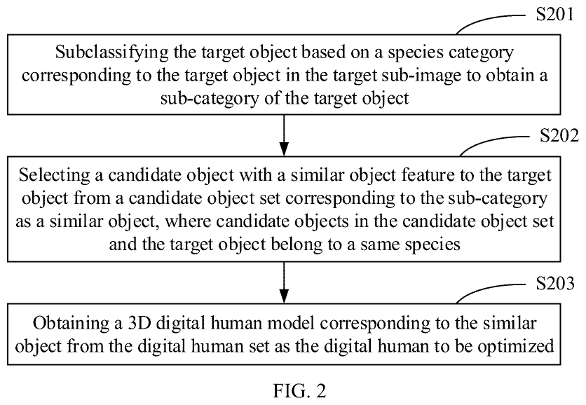

In some embodiments, the target object and the digital human to be optimized usually belong to different species in essence. In this case, in order to improve the accuracy in selecting the digital human to be optimized and improve the compatibility between the digital human to be optimized and the target object, the step of selecting the digital human to be optimized that is compatible with the target object from the cartoon digital human set based on the target sub-image in the embodiment of the present disclosure may be implemented as operations shown in FIG. 2, including:

S201: subclassifying the target object based on a species category corresponding to the target object in the target sub-image to obtain a sub-category of the target object.

For example, if the target object is a pet cat, the corresponding species category is cat category. If the target object is a dog, the corresponding species category is dog category. Cats and dogs are merely major categories, and beneath them are more detailed sub-categories.

In the embodiment of the present disclosure, a classification model corresponding to the species category of the target object may be used to further subclassify the target object. Taking cats as an example, training samples may be collected, including images of cats and their corresponding sub-category labels. The classification model applicable to the cat species can be obtained by supervised training of the initial classification model for cats through the training samples. For dogs, similarly, training samples may be collected, including images of dogs and their corresponding sub-category labels. The classification model applicable to the dog species can be obtained by supervised training of the initial classification model for dogs through the training samples.

Under different sub-categories, the appearances, habits and others of objects included will vary. The target object can be better understand and recognized by sub-classification, to facilitate the selection of the compatible digital human to be optimized.

To this end, each sub-category is pre-associated with a candidate object set in the embodiment of the present disclosure. The candidate object set includes a plurality of objects sharing the same sub-category as the target object. Furthermore, in the embodiment of the present disclosure, for each candidate object, a corresponding 3D digital human model may be aesthetically designed therefor and associated therewith in advance. It can be understood that each candidate object has a corresponding 3D digital human model, and a plurality of candidate objects may correspond to the same 3D digital human model.

S202: selecting a candidate object with a similar object feature to the target object from a candidate object set corresponding to the sub-category as a similar object, where candidate objects in the candidate object set and the target object belong to a same species.

In some embodiments, the texture features of the target object and candidate objects may be extracted and matched to obtain the similar object.

In other embodiments, in order to improve the accuracy in selecting the similar object, a suitable similar object may be selected based on the reasoning and understanding capabilities of a large model in the embodiments of the present disclosure, which may be implemented as follows:

Step A1: extracting a first feature of the target object from the target sub-image and extracting second features of multiple candidate objects in the candidate object set based on a feature extraction large model.

“Large models” generally refer to models that are large in parameter scale and usually require a lot of computing resources to train and run in the fields of machine learning and artificial intelligence. Such models may include language models, image models, reinforcement learning models, and so on. These models are large in scale and can handle more complex tasks and data.

The feature extraction large model in the embodiment of the present disclosure is a large model that can extract features from images and has the computer vision processing capability. An encoder based on a transformer architecture in the CLIP (Contrastive Language-Image Pre-training) model may be used to extract the first feature of the target object and the second features of the candidate objects.

The advantages of the CLIP model lie in the strong versatility and zero-shot learning ability, making it perform well in practical applications, especially in the field of image retrieval and others. The CLIP model can uncover the relationship between the target object and the candidate objects, and improve the accuracy in retrieving the similar object.

Step A2: determining similarities between the second features of the multiple candidate objects and the first feature.

Step A3: selecting a candidate object corresponding to a second feature with a highest similarity as the similar object.

In the embodiment of the present disclosure, the difference and commonality between the target object and each candidate object can be accurately understood through the feature extraction large model, and the similar object can be retrieved more accurately with the help of the reasoning and understanding capabilities of the large model, so as to improve the effect of selecting the digital human to be optimized, improve the compatibility between the finally generated digital human and the target object, and thus improve the user experience.

S203: obtaining a 3D digital human model corresponding to the similar object from the digital human set as the digital human to be optimized.

In the embodiment of the present disclosure, in order to improve the effect of the initially selected digital human and improve the compatibility between the target object and the digital human to be optimized, the 3D digital human model is established based on the principle of aesthetic compatibility with the similar object.

For example, for objects in different sub-categories, the artist draws a 3D digital human model with aesthetic compatibility according to characteristics of an object in a sub-category.

Alternatively, appearance requirements for cartoon digital humans may be generated respectively for the objects in different sub-categories. For example, a prompt may be generated according to appearance and personality (lively or cute), and the large model may fine-tune the standard digital human model according to the prompt to generate a 3D digital human model with aesthetic compatibility. Even the corresponding 3D digital human models may be provided respectively for different poses and/or emotions of the same object under each sub-category. Thus, different poses and/or emotions can be precisely distinguished, to select the 3D digital human model with aesthetic compatibility.

Therefore, in order to solve the problem that it is difficult to directly match features between the target object and the digital human due to different species, the embodiment of the present disclosure introduces the candidate object set in the same sub-category as the target object as an intermediary, and can perform feature matching within the same species, improving the accuracy in selecting the digital human to be optimized. Furthermore, the accuracy in retrieving the compatible digital human to be optimized can be improved through selecting by sub-category.

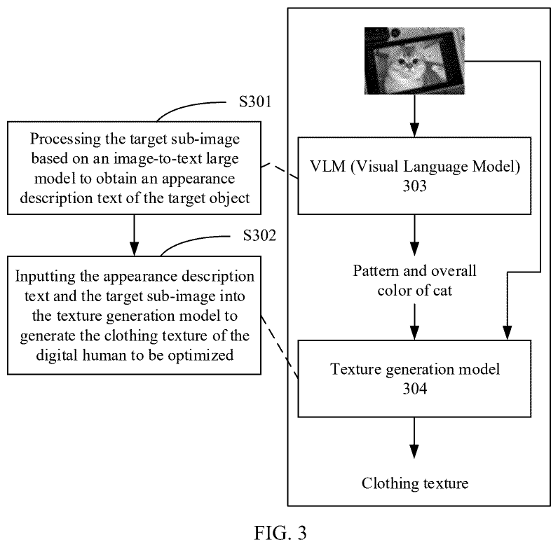

After the digital human to be optimized is selected, the appearance feature of the target object is transferred to the clothing of the digital human to be optimized to implement personification of the target object. In some embodiments, this process may be implemented as shown in FIG. 3:

S301: processing the target sub-image based on an image-to-text large model to obtain an appearance description text of the target object.

Here, the appearance description text is the text that describes the appearance feature of the target object. Taking a pet cat as an example, the pattern and fur color of the pet cat may be accurately described with the help of the understanding and reasoning abilities of the image-to-text large model. Then the appearance description text may be input into a texture generation model, which helps the subsequent texture generation model to generate the similar clothing texture.

In the embodiment of the present disclosure, in order to further improve the similarity between the generated clothing texture and the target object, the appearance description text and the target sub-image may be input into the texture generation model to generate the clothing texture of the digital human to be optimized in S302.

Therefore, the texture generation model can accurately understand the features of the clothing texture to be generated through the appearance expression of the image modality and the appearance expression of the text modality, improve the compatibility between the generated clothing texture and the target object and thus further associate the target object with the target digital human, improving the compatibility between the generated target digital human and the target object and thus improving the user experience.

For example, the image-to-text large model may be the VLM (Visual Language Model) 303 as shown in FIG. 3. The VLM 303 describes the pattern and overall color of the cat on the target sub-image to obtain the appearance description text of the cat. Then the appearance description text and the target sub-image of the cat are input into the texture generation model 304 built based on a diffusion model to obtain the clothing texture.

Here, the LDM (Latent Diffusion Model) may be selected as the diffusion model; and the LDM is a generator based on the diffusion model, and reduces the computational complexity and improves the generation efficiency and quality of clothing texture by operating in the latent space instead of the pixel space.

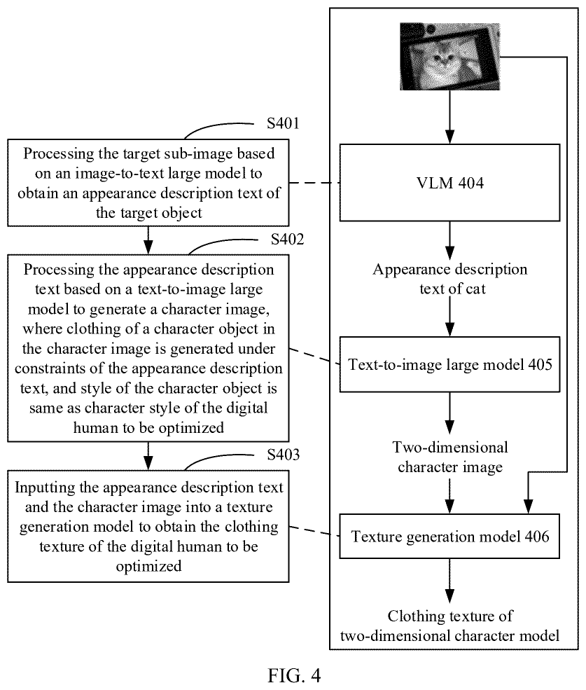

In other embodiments, the step of generating the clothing texture of the digital human to be optimized based on the appearance feature of the target object in the target sub-image may also be implemented as shown in FIG. 4:

S401: processing the target sub-image based on an image-to-text large model to obtain an appearance description text of the target object.

This step is the same as S301 and will not be repeated here.

S402: processing the appearance description text based on a text-to-image large model to generate a character image, where clothing of a character object in the character image is generated under constraints of the appearance description text, and style of the character object is same as character style of the digital human to be optimized.

In other words, the appearance description text may be converted into a planar character image based on the text-based image model. Since the character object in the character image has the same style as the digital human to be optimized, the character object can be better aligned with the digital human to be optimized and better describe the requirement of the clothing texture to be generated.

S403: inputting the appearance description text and the character image into a texture generation model to obtain the clothing texture of the digital human to be optimized.

Therefore, in the embodiment of the present disclosure, obtaining the appearance description text of the target object first can obtain rich appearance details of the target object, to help the texture generation model to understand and generate the clothing texture. Moreover, by converting the appearance description text into the character object in the same style, the image input to the texture generation model can be better aligned with the digital human to be optimized, improving the generation effect and quality of the clothing texture, and thus improving the quality of the generated target digital human.

For example, the image-to-text large model may be the VLM 404 as shown in FIG. 4. The VLM 404 describes the pattern and overall color of the cat on the target sub-image to obtain the appearance description text of the cat. Then the appearance description text is input into the text-to-image large model 405 to obtain the two-dimensional character image. Then the appearance description text and the character image are input into the texture generation model 406 built based on the diffusion model to obtain the clothing texture of the two-dimensional character model.

In an embodiment of the present disclosure, after the target digital human is constructed based on the clothing texture, the target digital human may be driven by a preset parameter, which may be implemented as follows: the target digital human is determined based on at least one of the following preset driving parameters: a skeletal driving parameter, a facial expression driving parameter or a text-to-speech driving parameter.

The target digital human may be determined by combining skeletal point-driven, facial-driven and TTS (Text-to-Speech) technologies.

For example, after the target digital human is generated, the target digital human is not statically displayed to the user, but is moved by the preset driving parameters and interacts with the user in a human-like manner. For example, one way of greeting may be chosen to utilizes the body language combined with the TTS technology to drive the target digital human to greet the user. For example, the target digital human may also be driven to perform a singing and dancing show.

In the embodiment of the present disclosure, the target digital human can be driven from different aspects such as skeleton, face and speech to perform human-like operations by presetting the driving parameters, so as to improve the user experience.

In addition, the embodiment of the present disclosure may also rely on large models to interact with the user, which may be implemented as:

Step B1: obtaining interaction information.

During implementation, the user may send the interaction information through single modality such as speech, text or video or through a combination of multiple modalities.

Step B2: processing the interaction information based on a large language model to obtain a response text for the interaction information.

The large language model may understand the interaction information, thereby generating a personalized response text via the logical reasoning capability of the large language model.

For the multimodal interaction information, the content of the user's interaction information may be understood first through a multimodal large model, to map the features of media modalities (such as speech and image) to the text feature space and then process them by the large language model to obtain the response text.

Step B3: generating a driving parameter of the target digital human based on the response text.

Based on the TTS technology, the target digital human can express the response text to achieve the personified intelligent interaction.

Step B4: driving the target digital human based on the driving parameter.

During implementation, the driving parameter may not only include the mouth shape required for the target digital human to express the response text, but also coordinate with appropriate facial expressions and/or actions to make the target digital human more personified, improving the user experience.

In summary, the embodiment of the present disclosure supports the flexible and personalized interaction between the user and target digital human, thereby enabling the target digital human to be presented to the user in the form of an intelligent agent, and thus improving the user experience.

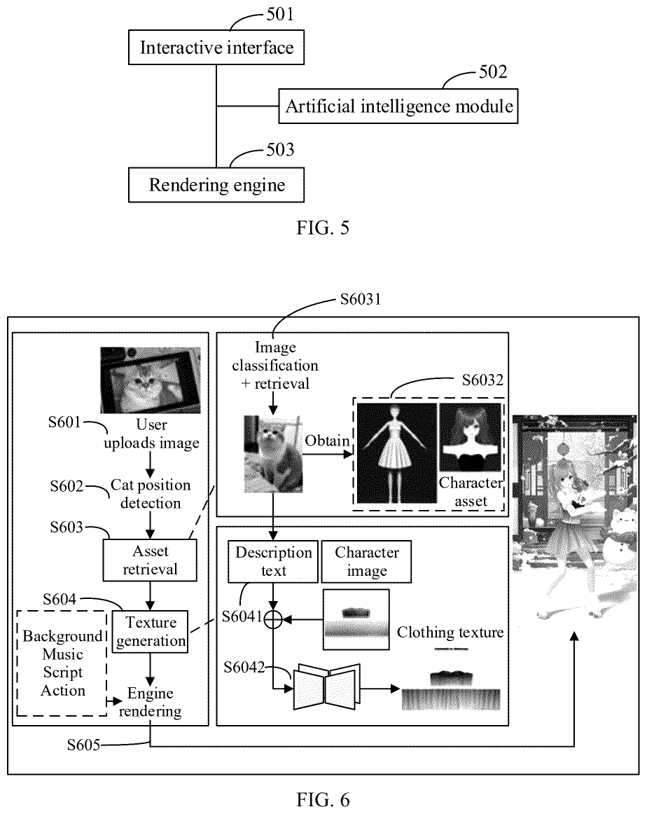

Based on the same technical concept, an embodiment of the present disclosure further provides an intelligent agent, as shown in FIG. 5, including:
an interactive interface 501 configured to obtain an image to be processed;
an artificial intelligence module 502 configured to segment a target object from the image to be processed to obtain a target sub-image; select a digital human to be optimized that is compatible with the target object from a digital human set based on the target sub-image; and generate clothing texture of the digital human to be optimized based on an appearance feature of the target object in the target sub-image; and
a rendering engine 503 configured to apply the clothing texture to the digital human to be optimized to obtain a target digital human; and drive the target digital human.

Moreover, in order to facilitate front-end display, the driving result of the target digital human may also be output to the front end through the interactive interface.

Here, various operations performed by the intelligent agent have been described in the aforementioned method embodiments and will not be repeated here.

In summary, taking a pet cat as an example, the pet cat is personified to illustrate the method for generating the digital human provided in the embodiments of the present disclosure. As shown in FIG. 6, the method includes:

In S601, a user may upload an image of the pet cat via a smart terminal.

In S602, the intelligent agent performs target detection on the image of the pet cat through a target detection model to obtain a 2D box of the pet cat, and crops the 2D box from the image of the pet cat to obtain a target sub-image.

In S603, the intelligent agent performs asset retrieval, specifically including:

S6031: the intelligent agent subclassifies the pet cat through a classification model to obtain the sub-category of the pet cat, and detects a similar cat that resembles the pet cat from the cat set corresponding to the sub-category.

S6032: the intelligent agent retrieves the character asset corresponding to the similar cat and then obtains a two-dimensional character model corresponding to the similar cat.

In S604, the intelligent agent generates clothing texture of the two-dimensional character model, specifically including:

S6041: the intelligent agent generates an appearance description text of the pet cat through the VLM, and generates a character image in the same two-dimensional style based on the appearance description text, where the clothing parameters of a character in the two-dimensional character image are generated based on the appearance description text.

S6042: the intelligent agent inputs the appearance description text and character image into a texture generation model to obtain the clothing texture of the two-dimensional character model.

In S605, the intelligent agent applies the generated clothing texture to the two-dimensional character model through the rendering engine, and drives the two-dimensional character model in combination with the background, music, script and action, to facilitate interaction with the user.

The present disclosure provides an innovative application of AI (Artificial Intelligence) technology. This application personifies the user's pet cat as a two-dimensional character and empowers it with AI, to present to the user in the form of an intelligent agent. This function aims to deepen the emotional bond of the user and provide the user with a better companionship experience.

In summary, the present disclosure integrates the pattern recognition, large model reasoning, 3D rendering and other technologies to create a novel and attractive intelligent agent application of virtual humans. The chain of the intelligent agent application technology includes a plurality of core modules: position detection, asset retrieval, clothing texture generation, driving and engine rendering.

The digital human model and clothing texture map used in the embodiments of the present disclosure conform to the universal model storage format, so any traditional rendering engine can be used to implement driving and real-time interaction of “human body & expression”. In practical applications, engines embedded in the app (Application) or in the cloud can also be used for driving, rendering and interaction. In addition, the output of the driving result in the form of a video is supported. For example, a video in which the two-dimensional character dances, gives New Year's greetings, says hello and performs other actions is recorded according to actual needs, and output to the user as a result.

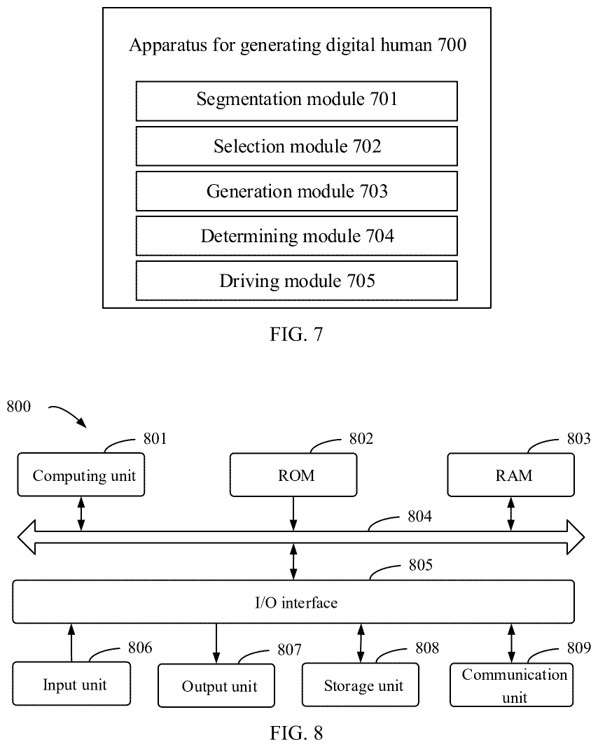

Based on the same technical concept, an embodiment of the present disclosure further proposes an apparatus 700 for generating a digital human, as shown in FIG. 7, including:
a segmentation module 701 configured to segment a target object from an image to be processed to obtain a target sub-image;
a selection module 702 configured to select a digital human to be optimized that is compatible with the target object from a digital human set based on the target sub-image;
a generation module 703 configured to generate clothing texture of the digital human to be optimized based on an appearance feature of the target object in the target sub-image;
a determining module 704 configured to apply the clothing texture to the digital human to be optimized to obtain a target digital human; and
a driving module 705 configured to drive the target digital human.

In some embodiments, the selection module includes:
a classification unit configured to subclassify the target object based on a species category corresponding to the target object in the target sub-image to obtain a sub-category of the target object;
a selection unit configured to select a candidate object with a similar object feature to the target object from a candidate object set corresponding to the sub-category as a similar object, where candidate objects in the candidate object set and the target object belong to a same species; and
an obtaining unit configured to obtain a 3D digital human model corresponding to the similar object from the digital human set as the digital human to be optimized.

In some embodiments, the selection unit is specifically configured to:
extract a first feature of the target object from the target sub-image and extract second features of multiple candidate objects in the candidate object set based on a feature extraction large model;
determine similarities between the second features of the multiple candidate objects and the first feature; and
select a candidate object corresponding to a second feature with a highest similarity as the similar object.

In some embodiments, the generation module includes:
an image-to-text unit configured to process the target sub-image based on an image-to-text large model to obtain an appearance description text of the target object; and
a first texture generation unit configured to input the appearance description text and the target sub-image into a texture generation model to generate the clothing texture of the digital human to be optimized.

In some embodiments, the generation module includes:
an image-to-text unit configured to process the target sub-image based on an image-to-text large model to obtain an appearance description text of the target object;
a text-to-image unit configured to process the appearance description text based on a text-to-image large model to generate a character image, where clothing of a character object in the character image is generated under constraints of the appearance description text, and style of the character object is same as character style of the digital human to be optimized; and
a second texture generation unit configured to input the appearance description text and the character image into a texture generation model to obtain the clothing texture of the digital human to be optimized.

In some embodiments, the driving module includes:
a first driving unit configured to determine the target digital human based on at least one of following preset driving parameters:
a skeletal driving parameter, a facial expression driving parameter or a text-to-speech driving parameter.

In some embodiments, the driving module includes:
an obtaining unit configured to obtain interaction information;
a reasoning unit configured to process the interaction information based on a large language model to obtain a response text for the interaction information;
a synthesis unit configured to generate a driving parameter of the target digital human based on the response text; and
a second driving unit configured to drive the target digital human based on the driving parameter.

In some embodiments, the digital human to be optimized includes a two-dimensional character model.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

FIG. 8 shows a schematic block diagram of an exemplary electronic device 800 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 8, the device 800 includes a computing unit 801 that may perform various appropriate actions and processes according to a computer program stored in a Read-Only Memory (ROM) 802 or a computer program loaded from a storage unit 808 into a Random Access Memory (RAM) 803. Various programs and data required for an operation of device 800 may also be stored in the RAM 803. The computing unit 801, the ROM 802 and the RAM 803 are connected to each other through a bus 804. The input/output (I/O) interface 805 is also connected to the bus 804.

A plurality of components in the device 800 are connected to the I/O interface 805, and include an input unit 806 such as a keyboard, a mouse, or the like; an output unit 807 such as various types of displays, speakers, or the like; the storage unit 808 such as a magnetic disk, an optical disk, or the like; and a communication unit 809 such as a network card, a modem, a wireless communication transceiver, or the like. The communication unit 809 allows the device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 801 performs various methods and processes described above, such as the method for generating the digital human. For example, in some implementations, the method for generating the digital human may be implemented as a computer software program tangibly contained in a computer-readable medium, such as the storage unit 808. In some implementations, a part or all of the computer program may be loaded and/or installed on the device 800 via the ROM 802 and/or the communication unit 809. When the computer program is loaded into the RAM 803 and executed by the computing unit 801, one or more steps of the method for generating the digital human described above may be performed. Alternatively, in other implementations, the computing unit 801 may be configured to perform the method for generating the digital human by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for generating a digital human, comprising:
segmenting a target object from an image to be processed to obtain a target sub-image;
selecting a digital human to be optimized that is compatible with the target object from a digital human set based on the target sub-image;
generating clothing texture of the digital human to be optimized based on an appearance feature of the target object in the target sub-image;
applying the clothing texture to the digital human to be optimized to obtain a target digital human; and
driving the target digital human.

2. The method of claim 1, wherein the selecting of the digital human to be optimized that is compatible with the target object from the digital human set based on the target sub-image, comprises:
subclassifying the target object based on a species category corresponding to the target object in the target sub-image to obtain a sub-category of the target object;
selecting a candidate object with a similar object feature to the target object from a candidate object set corresponding to the sub-category as a similar object, wherein candidate objects in the candidate object set and the target object belong to a same species; and
obtaining a 3D digital human model corresponding to the similar object from the digital human set as the digital human to be optimized.

3. The method of claim 2, wherein the selecting of the candidate object with the similar object feature to the target object from the candidate object set corresponding to the sub-category as the similar object, comprises:
extracting a first feature of the target object from the target sub-image and extracting second features of multiple candidate objects in the candidate object set based on a feature extraction large model;
determining similarities between the second features of the multiple candidate objects and the first feature; and
selecting a candidate object corresponding to a second feature with a highest similarity as the similar object.

4. The method of claim 1, wherein the generating of the clothing texture of the digital human to be optimized based on the appearance feature of the target object in the target sub-image, comprises:
processing the target sub-image based on an image-to-text large model to obtain an appearance description text of the target object; and
inputting the appearance description text and the target sub-image into a texture generation model to generate the clothing texture of the digital human to be optimized.

5. The method of claim 1, wherein the generating of the clothing texture of the digital human to be optimized based on the appearance feature of the target object in the target sub-image, comprises:
processing the target sub-image based on an image-to-text large model to obtain an appearance description text of the target object;
processing the appearance description text based on a text-to-image large model to generate a character image, wherein clothing of a character object in the character image is generated under constraints of the appearance description text, and style of the character object is same as character style of the digital human to be optimized; and
inputting the appearance description text and the character image into a texture generation model to obtain the clothing texture of the digital human to be optimized.

6. The method of claim 1, wherein the driving of the target digital human, comprises:
determining the target digital human based on at least one of following preset driving parameters:
a skeletal driving parameter, a facial expression driving parameter or a text-to-speech driving parameter.

7. The method of claim 1, wherein the driving of the target digital human, comprises:
obtaining interaction information;
processing the interaction information based on a large language model to obtain a response text for the interaction information;
generating a driving parameter of the target digital human based on the response text; and
driving the target digital human based on the driving parameter.

8. The method of claim 1, wherein the digital human to be optimized comprises a two-dimensional character model.

9. An intelligent agent, comprising:
an interactive interface configured to obtain an image to be processed;
an artificial intelligence module configured to:
segment a target object from the image to be processed to obtain a target sub-image;
select a digital human to be optimized that is compatible with the target object from a digital human set based on the target sub-image; and
generate clothing texture of the digital human to be optimized based on an appearance feature of the target object in the target sub-image; and
a rendering engine configured to:
apply the clothing texture to the digital human to be optimized to obtain a target digital human; and
drive the target digital human.

10. The intelligent agent of claim 9, wherein the artificial intelligence module is configured to:
subclassify the target object based on a species category corresponding to the target object in the target sub-image to obtain a sub-category of the target object;
select a candidate object with a similar object feature to the target object from a candidate object set corresponding to the sub-category as a similar object, wherein candidate objects in the candidate object set and the target object belong to a same species; and
obtain a 3D digital human model corresponding to the similar object from the digital human set as the digital human to be optimized.

11. The intelligent agent of claim 10, wherein the artificial intelligence module is configured to:
extract a first feature of the target object from the target sub-image and extracting second features of multiple candidate objects in the candidate object set based on a feature extraction large model;
determine similarities between the second features of the multiple candidate objects and the first feature; and
select a candidate object corresponding to a second feature with a highest similarity as the similar object.

12. The intelligent agent of claim 9, wherein the artificial intelligence module is configured to:
process the target sub-image based on an image-to-text large model to obtain an appearance description text of the target object; and
input the appearance description text and the target sub-image into a texture generation model to generate the clothing texture of the digital human to be optimized.

13. The intelligent agent of claim 9, wherein the artificial intelligence module is configured to:
process the target sub-image based on an image-to-text large model to obtain an appearance description text of the target object;
process the appearance description text based on a text-to-image large model to generate a character image, wherein clothing of a character object in the character image is generated under constraints of the appearance description text, and style of the character object is same as character style of the digital human to be optimized; and
input the appearance description text and the character image into a texture generation model to obtain the clothing texture of the digital human to be optimized.

14. The intelligent agent of claim 9, wherein the rendering engine is configured to:
determine the target digital human based on at least one of following preset driving parameters:
a skeletal driving parameter, a facial expression driving parameter or a text-to-speech driving parameter.

15. The intelligent agent of claim 9, wherein the rendering engine is configured to:
obtain interaction information;
process the interaction information based on a large language model to obtain a response text for the interaction information;
generate a driving parameter of the target digital human based on the response text; and
drive the target digital human based on the driving parameter.

16. The intelligent agent of claim 9, wherein the digital human to be optimized comprises a two-dimensional character model.

17. An electronic device, comprising:
at least one processor; and
a memory connected in communication with the at least one processor;
wherein the memory stores an instruction executable by the at least one processor, and the instruction, when executed by the at least one processor, enables the at least one processor to execute:
segmenting a target object from an image to be processed to obtain a target sub-image;
selecting a digital human to be optimized that is compatible with the target object from a digital human set based on the target sub-image;
generating clothing texture of the digital human to be optimized based on an appearance feature of the target object in the target sub-image;
applying the clothing texture to the digital human to be optimized to obtain a target digital human; and
driving the target digital human.

18. The electronic device of claim 17, wherein the instruction, when executed by the at least one processor, enables the at least one processor to execute the selecting of the digital human to be optimized that is compatible with the target object from the digital human set, by:
subclassifying the target object based on a species category corresponding to the target object in the target sub-image to obtain a sub-category of the target object;
selecting a candidate object with a similar object feature to the target object from a candidate object set corresponding to the sub-category as a similar object, wherein candidate objects in the candidate object set and the target object belong to a same species; and
obtaining a 3D digital human model corresponding to the similar object from the digital human set as the digital human to be optimized.

19. The electronic device of claim 18, wherein the instruction, when executed by the at least one processor, enables the at least one processor to execute the selecting of the candidate object with the similar object feature to the target object from the candidate object set corresponding to the sub-category as the similar object, by:
extracting a first feature of the target object from the target sub-image and extracting second features of multiple candidate objects in the candidate object set based on a feature extraction large model;
determining similarities between the second features of the multiple candidate objects and the first feature; and
selecting a candidate object corresponding to a second feature with a highest similarity as the similar object.

20. A non-transitory computer-readable storage medium storing a computer instruction thereon, wherein the computer instruction is used to cause a computer to execute the method of claim 1.
